(19) United States
(12) Patent Application Publication
(10) Pub. No.: US 2003/0071764 A1
(43) Pub. Date: Apr. 17, 2003

(54) Method and apparatus for dual sided electronic shelf label

(75) Inventor: Jeffrey R. Peterson, Suwanee, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 09/976,529

(22) Filed: Oct. 11, 2001

(51) Int. Cl. G09G 5/00

(52) U.S. Cl. 345/1.1

(57) ABSTRACT

Systems and techniques for an electronic shelf label (ESL) comprising two displays disposed on opposing sides of the ESL are described. The dual sided ESL of the present invention allows a retailer to display price, merchandising and operational information to consumers and store employees from multiple viewing angles utilizing a single ESL. In one aspect, the ESL is mounted perpendicular to a shelf rail, allowing visibility to both sides. This perpendicular mounting technique requires less linear space along the shelf rail, allowing product density to be increased for small products. In another aspect, the ESL is mounted on a free standing housing, allowing the ESL to be placed on various displays throughout the retail establishment. The ESL in accordance with the present invention may display the same information on both sides of the ESL. In another aspect, the ESL may display different information on each side of the ESL.

### FIELD OF THE INVENTION

The present invention relates generally to improvements in electronic shelf label (ESL) systems used in transaction establishments. More specifically, the present invention relates to improved methods and apparatus for providing a dual sided ESL including two displays disposed on opposing sides of the ESL.

### BACKGROUND OF THE INVENTION

ESL systems typically include a plurality of ESLs for each merchandise item in a store. ESLs display the price or promotional information of corresponding merchandise items on store shelves and are typically attached to a rail along the leading edge of the shelves. A store may contain thousands of ESLs to display the prices of the merchandise items. The ESLs are coupled to a central server where information about the ESLs is typically maintained in an ESL data file which contains ESL identification information and ESL merchandise item information. The central server sends messages, including price change messages, to the ESLs. Typical ESLs include a single display for displaying the price or promotional information and are attached to the shelf rail with the display facing outward into the aisle.

### SUMMARY OF THE INVENTION

The present invention advantageously provides systems and methods for an improved ESL comprising two displays disposed on opposing sides of the ESL. The dual sided ESL of the present invention allows a retailer to display price, merchandising and operational information to consumers and store employees from multiple viewing angles utilizing a single ESL.

In one aspect, the ESL is mounted perpendicular to a shelf rail, allowing visibility to both sides. This perpendicular mounting technique requires less linear space along the shelf rail, allowing product density to be increased for small products. In another aspect, the ESL is mounted on a free standing housing, allowing the ESL to be placed on various displays throughout the retail establishment.

An ESL in accordance with the present invention may display the same information on both sides of the ESL. In another aspect, the ESL may display different information on each side of the ESL.

A more complete understanding of the present invention, as well as further features and advantages of the invention, will be apparent from the following detailed description and the accompanying drawings.

### BRIEF DESCRIPTION OF THE DRAWINGS

FIG. 1 is a block diagram of a transaction management system in accordance with the present invention;

FIG. 2A shows a view of a first side of an ESL in accordance with the present invention;

FIG. 2B shows a view of a second side of an ESL in accordance with the present invention;

FIG. 2C shows a side view of an ESL in accordance with the present invention;

FIG. 3A shows a perspective view of an ESL attached to a shelf edge in accordance with the present invention;

FIG. 3B shows a perspective view of an ESL attached to a free standing mount in accordance with the present invention;

FIG. 4 shows a block diagram of an ESL in accordance with one aspect of the present invention; and

FIG. 5 illustrates a method of displaying information by a dual sided ESL in accordance with the present invention.

### DETAILED DESCRIPTION

The present invention now will be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

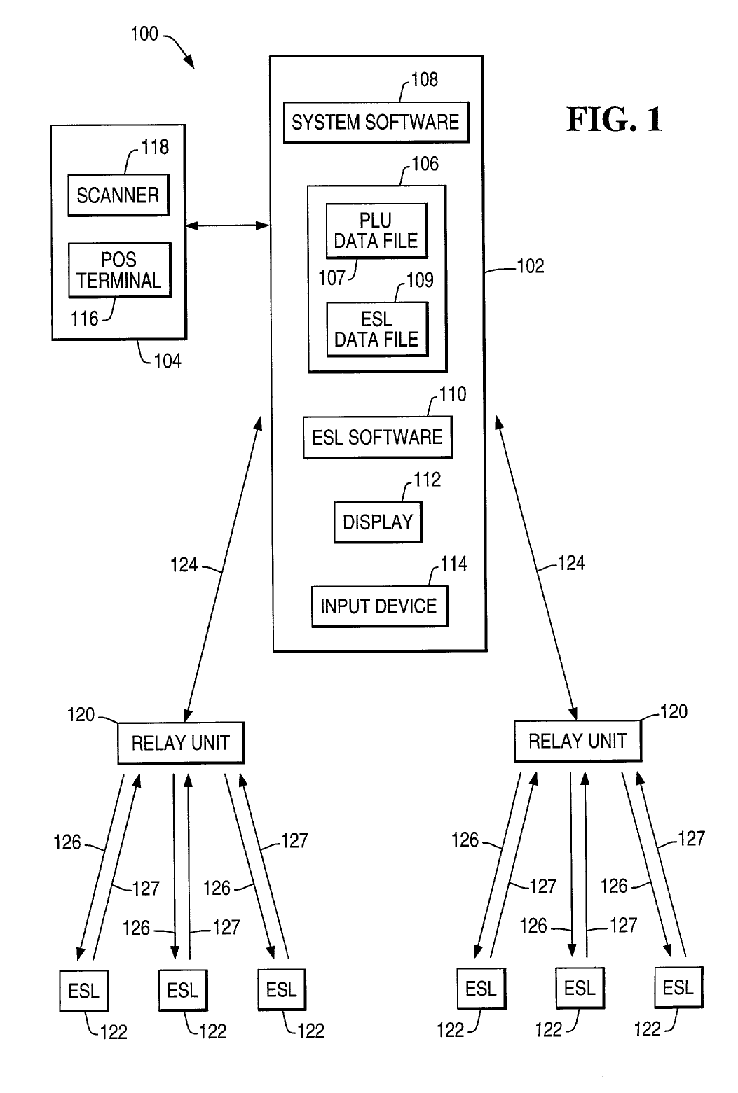

FIG. 1 shows a transaction management system 100 in accordance with the present invention. The system 100 includes a host computer system 102 and a point-of-service (POS) system 104. Here, components 102 and 104 are shown as separate components that are networked together, but they and their subcomponents may also be combined or divided in various ways. Thus, host computer system 102 may be a POS terminal which doubles as a host computer for a network of other POS terminals.

The host computer system 102 includes a storage medium 106, system software 108, ESL software 110, a display 112 and an input device 114. The storage medium 106 includes a PLU data file 107 which stores item prices which are available for distribution to a POS terminal 116 by the host system 102. Alternatively, provision may be made for a bar code scanner 118 to directly access the PLU data file 107. The storage medium 106 also includes ESL data file 109 which contains item information, such as a PLU number and ESL identification information for each of the ESLs 122. The system 102 executes system software 108 which updates the contents of storage medium 106 and performs other system functions, as described in greater detail below. Input device 114 is preferably a keyboard, but it will be recognized that data can be entered in a variety of alternative manners.

POS system 104 includes bar code scanner 118 and POS terminal 116.

The system 100 also includes relay units 120 and ESLs 122. The relay units 120 may be suitably mounted in or near the ceiling of the retail establishment.

ESL software 110 records, schedules, and transmits all messages to ESLs 122. ESL software 110 controls the transmission of messages, including price change messages, to ESLs 122 utilizing relay units 120 which are placed periodically across a retail establishment. These messages are sent to the relay array units 120 through communications link 124. Communications link 124 may suitably utilize radio frequency (RF) communication, infrared (IR) communication, a wired link, or some combination of communication techniques. After receiving a message from the host system 102, the relay units 120 then transmit the message to the ESLs 122 utilizing a further communications link 126, which may suitably utilize RF communication, IR communication, a wired link or some combination of communication techniques. In an alternate embodiment, host system 102 may communicate directly with ESLs 122.

After receiving a message, the ESLs 122 may respond with an acknowledgement which is transmitted to the relay units 120 over communication link 127. The relay units 120 would then retransmit the acknowledgement message to the host system 102 over communication link 124.

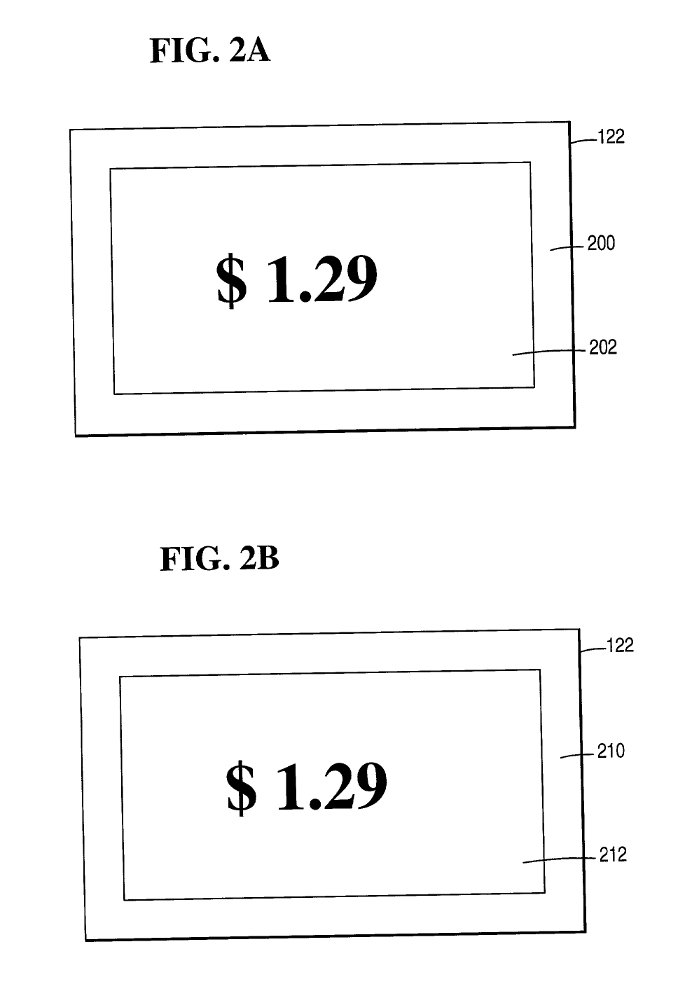

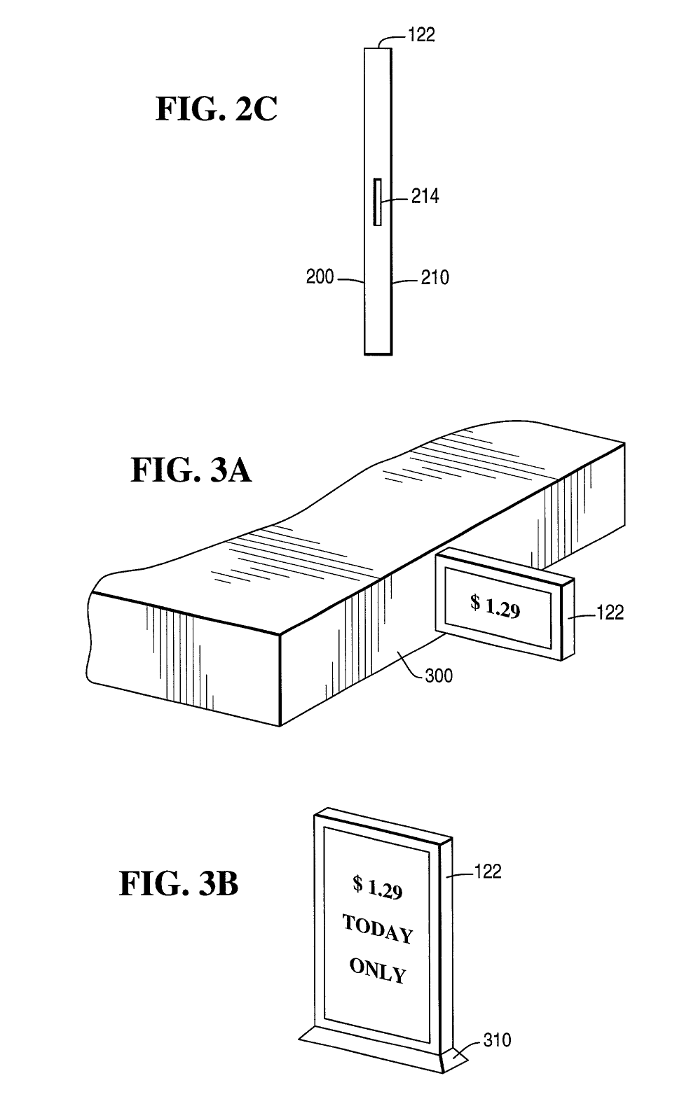

FIG. 2A shows a first side 200 of the ESL 122 which includes a first display 202 for displaying price information, promotional data or other types of information. FIG. 2B shows a second side 210 of the ESL 122 which includes a second display 212 for displaying price information. A side view of the ESL 122 is shown in FIG. 2C. Battery access may be provided through a slot 214 on a side of the ESL 122. As seen in FIGS. 2A-2C, the ESL 122 provides a dual sided ESL with each of the opposing sides including a display. The present invention allows a retailer to display information to consumers and store employees from multiple view angles while utilizing only a single ESL.

As shown in FIG. 3A, the ESL 122 may be mounted perpendicular to a shelf rail 300, thus requiring reduced liner space along the shelf rail 300. This perpendicular mounting technique requires less linear space along the shelf rail 300, allowing product density to be increased for small products. In another aspect, as seen in FIG. 3B the ESL 122 may be mounted on a free standing housing 310, allowing the ESL 122 to be placed on various displays throughout the retail establishment.

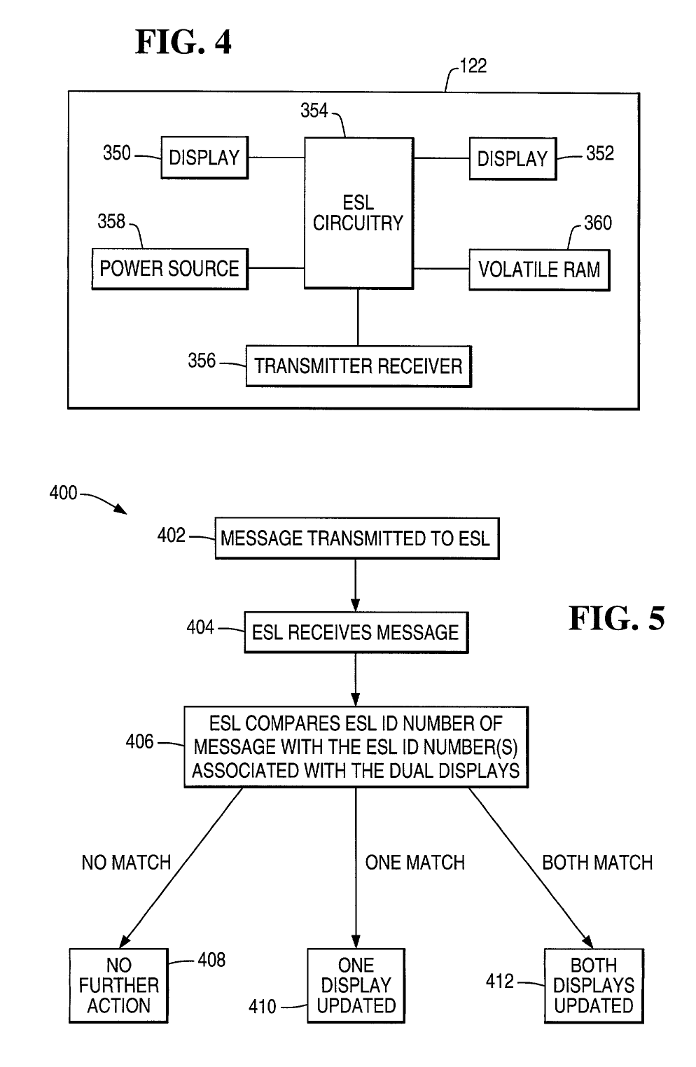

FIG. 4 shows a block diagram of the ESL 122 in accordance with the present invention. Displays 350 and 352 are disposed on opposing sides of the ESL 122 and display information, such as item price and related data. ESL 122 includes a transmitter/receiver 356 for transmitting messages and receiving messages. The transmitter/receiver may utilize RF communication, IR communication, a wired link or some combination of communication techniques. A power source 358 provides power for the operation of ESL 122. The operation of ESL 122 is controlled by ESL circuitry 354. ESL circuitry 354 decodes incoming messages received, and performs any actions indicated by the messages. For example, if a price change message is received, the ESL circuitry 354 would cause the displays 350 and 352 to be updated with the new price information. Volatile RAM 360 stores one or more ESL identification numbers and any displayed messages. ESL circuitry 354 may also include a variety of components such as timers and other electronic components. Since many components, such as the transmitter/receiver which requires a relatively large amount of power to operate, are shared by the two displays, the dual sided ESL consumes less total power than two traditional single sided ESLs.

In one aspect of the present invention, a single ESL identification (ID) number identifies the ESL, allowing both displays to display the same information. The host computer communicates with such a dual sided ESL 122 in substantially the same fashion as a single sided ESL. Utilizing a single ESL identification number allows the host computer to update both of the displays by sending a single command to the ESL.

In another aspect of the present invention, two ESL ID numbers identify the ESL, with each display being assigned an ESL ID number. The host computer communicates with such a dual sided ESL 122 by transmitting individual messages addressed to each ESL identification number. For example, if an incoming price change message contains the ESL identification number of the second display, the ESL circuitry 204 will cause the second display to be updated with the new price while leaving the first display unchanged.

FIG. 5 shows a method 400 of displaying information by a dual sided ESL in an ESL, such as ESL 122a, in accordance with the present invention. In a first step 402, a host computer transmits a message to an ESL, such as ESL 122, instructing the ESL to display text or price information. In step 404, the ESL receives the message. In step 406, the ESL circuitry determines if the ESL ID number of the message matches the ESL ID number of either display. If there is no match, the method continues to step 408 and no further action is taken by the ESL. If the ESL ID number of the message matches the ESL ID number of one of the displays, the method continues to step 410 and that display is updated to display the text or price information. If the ESL ID number of the message matches the ESL ID number of both of the displays, the method continues to step 412 and both displays are updated to display the text or price information.

It will be apparent to those skilled in the art that various modifications and variations can be made in the present invention without departing from the spirit and scope of the present invention. Thus, it is intended that the present invention cover the modifications and variations of this invention provided they come within the scope of the appended claims and their equivalents. For example, while the invention has been disclosed in terms of a single display disposed on each side of the ESL, multiple displays maybe utilized on each side of the ESL.

I claim:

1. An electronic shelf label (ESL) comprising:
a first display disposed on a first side of the ESL for displaying information;
a second display disposed on a second side opposed to the first side of the ESL for displaying information;
a memory device for storing the information to be displayed and at least one ESL identification number;
communication circuitry for receiving commands; and
ESL circuitry for controlling the operation of both the first display and the second display.

2. The ESL of claim 1 wherein a single ESL identification number is associated with both displays.

3. The ESL of claim 2 wherein both the first display and the second display display the same information.

4. The ESL of claim 1 wherein a first ESL identification number is associated with the first display and a second ESL identification number is associated with the second display.

5. The ESL of claim 4 wherein the first display displays a first information and the second display displays a second information, wherein the first information differs from the second information.

6. The ESL of claim 1 wherein the communication circuitry receives a command from a host computer directing the ESL to display a message on the first display.

7. The ESL of claim 1 wherein the communication circuitry receives a command from a host computer directing the ESL to display a message on both the first display and the second display.

8. The ESL of claim 1 wherein the ESL is mounted on a shelf rail and perpendicular to the shelf rail.

9. A method of displaying information by a dual sided electronic shelf label (ESL) having a first display and a second display, the first display and the second display disposed on opposing sides of the ESL, the method comprising the steps of:
transmitting a message to an ESL containing an update display command;
receiving the message by the ESL;
determining if an ESL identification (ID) number contained in the message matches an ESL ID number associated with either the first display or the second display;
if the ESL ID number contained in the message does not match an ESL ID number associated with either the first display or the second display, maintaining current display contents of the first display and the second display;
if the ESL ID number contained in the message matches an ESL ID number associated with both the first display and the second display, updating the first display and the second display to display information contained in the update display command; and
if the ESL ID number contained in the message matches an ESL ID number associated with only the first display, updating the first display to display information contained in the update display command, and maintaining current display contents of the second display.
